(19) United States
(12) Patent Application Publication
(10) Pub. No.: US 2002/0194508 A1
(43) Pub. Date: Dec. 19, 2002

(54) Method, apparatus, and program for extending the global sign-on environment to the desktop

(75) Inventors: Luis Benicio Casco-Arias Sanchez, Austin, TX (US); Richard Jay Cohen, Austin, TX (US); Yvonne Doray Lendacky, Round Rock, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/881,918

(22) Filed: Jun. 14, 2001

(51) Int. Cl. H04L 9/32

(52) U.S. Cl. 713/202

(57) ABSTRACT

A global sign-on system integrates global sign-on functionality into the desktop, such that global sign-on targets can be represented as icons or shortcuts, thus making the desktop a global sign-on environment. Global sign-on may be configured with integrated login so that a user may log into the operating system or network environment and select sign-on targets using the familiar desktop environment. Global sign-on targets may then be selected by interaction with icons or start menu items without having to enter additional identifications or passwords.

### BACKGROUND OF THE INVENTION

1. Technical Field

The present invention relates to data processing systems and, in particular, to global sign-on in a network environment. Still more particularly, the present invention provides a method, apparatus, and program for extending the global sign-on environment to the client desktop.

2. Description of Related Art

System administration in a distributed environment requires maintaining secure access to multiple applications and machines. System administrators must implement security policies that afford access to authorized users while avoiding security risks posed by network access, dial-up lines, and physical access to machines. Other than restricting physical access to a site or machine, passwords are a primary defense against unauthorized access to applications and other resources.

Password requirements are often difficult for the end-user to comply with, however. For example, password aging polices may require that the end-user change the password at frequent intervals. Nontrivial passwords may be required that are difficult to remember. Password security policy often prohibits an end-user from writing a password down, making it even more difficult to remember a password. Prohibitions may exist against using the same password more than once. The end-user may have several user identifications and passwords for different applications and machines. The difficulty of remembering multiple and changing passwords and user IDs may tempt the end-user to write passwords and user IDs down or use the same password repeatedly, thus compromising security. The end-user's inability to maintain this information imposes overhead on the system administrator who must respond to end-users that have forgotten their passwords.

Global sign-on increases security while reducing the difficulties imposed by security requirements on the end-user and system administrator. Global sign-on authenticates the end-user and maintains the login data (user ID and password) for all systems and applications to which the end-user requires access. The end-user may authenticate to global sign-on through a graphical user interface (GUI). The user may then access all applications and machines for which he or she is authorized through a launcher GUI, without having to perform a login for each application or machine.

However, the launcher GUI is a separate application that requires display and explicit interaction from the user to select targets for sign-on. The launcher GUI does not allow customization of the icons displayed. Therefore, the launcher GUI is not as intuitive as the more familiar operating system user interface. Furthermore, the user must remember which applications require sign-on and invoke them through the launcher GUI, while other applications are launched through the traditional operating system user interface.

Therefore, it would be advantageous to extend the global sign-on environment to the client desktop.

### SUMMARY OF THE INVENTION

The present invention integrates global sign-on functionality into the desktop, such that global sign-on targets can be represented as icons or shortcuts, thus making the desktop a global sign-on environment. Global sign-on may be configured with integrated login so that a user may log into the operating system or network environment and select sign-on targets without having to enter additional identifications or passwords.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating the main components of a global sign-on mechanism in accordance with a preferred embodiment of the present invention;

FIG. 5 is a high level illustration of the operation of the logon coordinator;

FIG. 6 is an example logon interface screen in accordance with a preferred embodiment of the present invention;

FIG. 7 is an example desktop user interface in accordance with a preferred embodiment of the present invention;

FIG. 8 is an example desktop user interface with global sign-on target shortcuts in accordance with a preferred embodiment of the present invention;

FIG. 9 illustrates a shortcut properties interface in accordance with a preferred embodiment of the present invention;

FIG. 10A is a flowchart illustrating a process for creating a desktop shortcut for a global sign-on target in accordance with a preferred embodiment of the present invention;

FIG. 10B is a flowchart of a process for creating a start menu item for a global sign-on target in accordance with a preferred embodiment of the present invention;

FIG. 11A is a flowchart illustrating a process for adding global sign-on targets to a desktop in accordance with a preferred embodiment of the present invention; and

FIG. 11B is a flowchart illustrating a process for adding a global sign-on target to the global sign-on system and the desktop in accordance with a preferred embodiment of the present invention.

### DETAILED DESCRIPTION OF THE PREFERRED EMBODIMENT

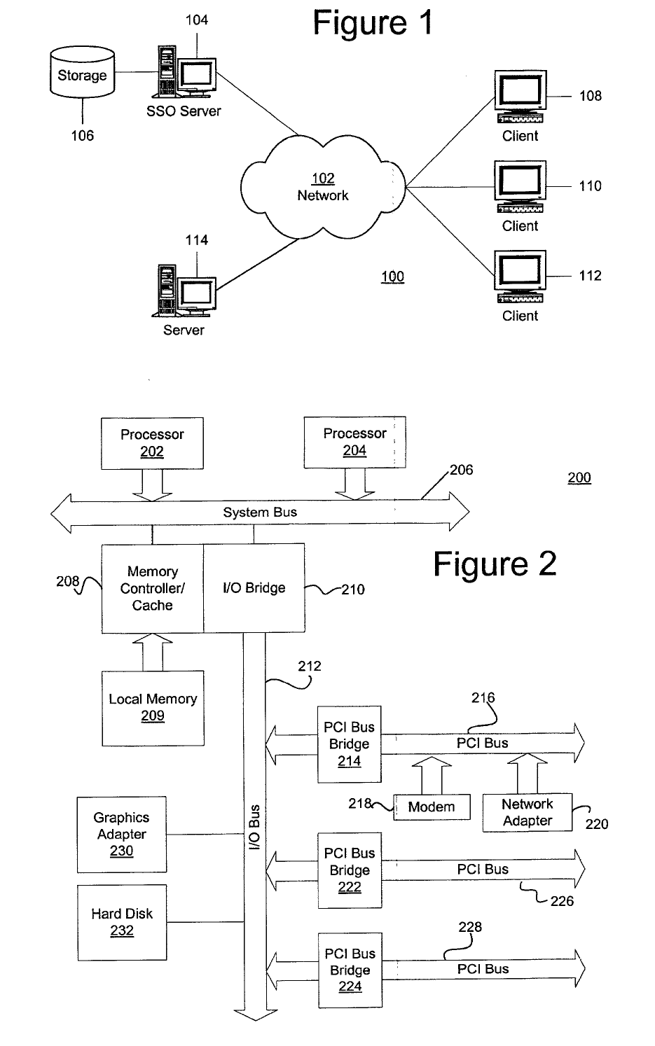

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, servers 104, 114 are connected to network 102. In addition, clients 108, 110, and 112 are connected to network 102. These clients 108, 110, and 112 may be, for example, personal computers or network computers. In the depicted example, servers 104, 114 provide data, such as boot files, operating system images, and applications to clients 108-112. Clients 108, 110, and 112 are clients to servers 104, 114. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

In accordance with a preferred embodiment of the present invention, server 104 is a global sign-on (GSO) server. The GSO server stores information that describes the global sign-on end-users and their targets, such as user identifications (IDs), passwords, hosts, and domains, in storage 106. Further details of the global sign-on system are described in U.S. Pat. No. 6,178,511 B1, titled “Coordinating User Target Logons in a Single Sign-on (SSO) Environment,” filed on Apr. 30, 1998 and issued to Cohen et al. on Jan. 23, 2001, herein incorporated by reference.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

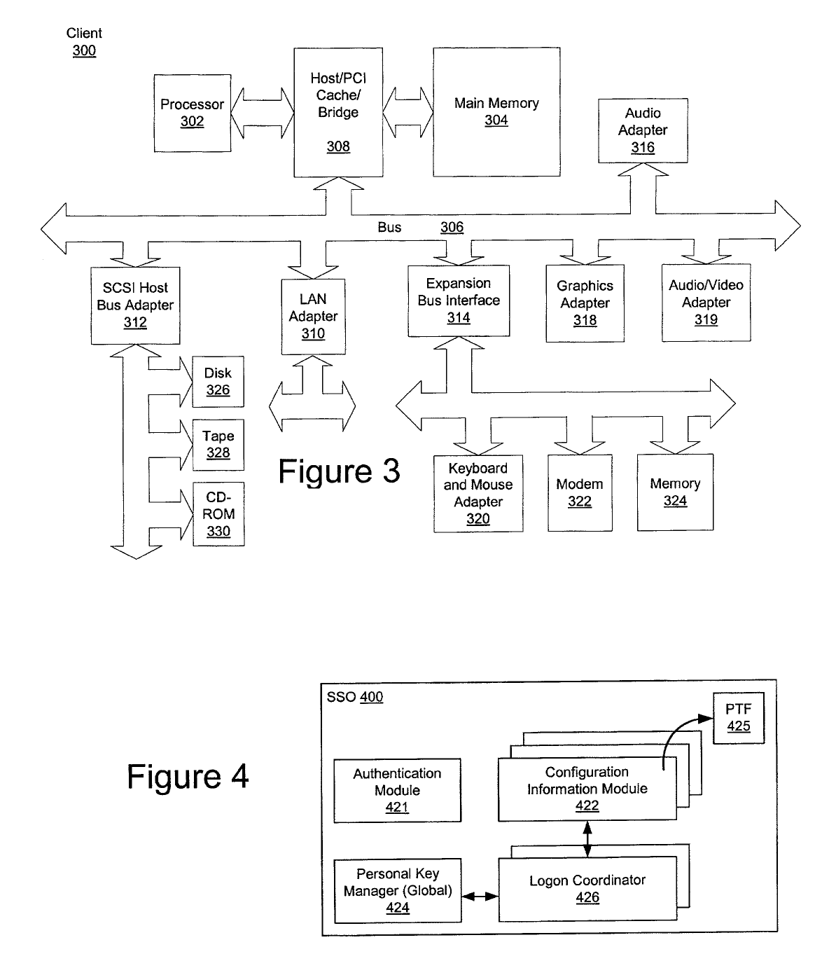

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With reference to FIG. 4, a block diagram illustrating the main components of a global sign-on mechanism is shown in accordance with a preferred embodiment of the present invention. Global sign-on 400 preferably includes an authentication module 421, a configuration information manager (CIM) 422, a personal key manager (PKM) 424, and a logon coordinator (LC) 426. In general, the authentication module 421 authenticates a given user to the remainder of the Global Sign-On mechanism. On systems with local operating system (OS) security, the authentication mechanism 421 may be integrated with the local OS authentication. The authentication module preferably supports different authentication mechanisms (e.g., secret key, smartcards, public/private key, and the like).

The configuration information manager (CIM) 422 includes information on how to logon to the applications configured on a given machine. Preferably, a CIM is supported on each client machine from which the GSO mechanism is provided. A given CIM typically is not globally accessible from other machines on the domain. Information in the CIM preferably is formatted according to a program template file (PTF) 425, as will be illustrated below in more detail. The CIM thus stores “configuration directives” identifying the given logon process and the methods required to access a particular application on the target resource. Support for new “programs” may be added using the PTF mechanism. For each program there is a description of the logon, logoff, and change password methods.

The PKM 424 contains information about users, systems and passwords they use to logon to those systems. Preferably, PKM 424 is a secure, globally accessible repository that facilitates the global sign-on process. Although not meant to be limiting, with respect to a given user, the PKM (as will be described) preferably stores such information as a username, a set of one or more password(s), and any other application environment-specific information such as domain name, hostname, application name, and the like. Because this access information preferably is centralized in the PKM, users can access their target resources with one sign-on from any workstation. They can also manage their passwords from this one repository, as will also be seen.

To this end, the logon coordinator 426 functions generally to retrieve the user's passwords from the PKM and uses them in conjunction with the target specific logon code (identifiable from the CIM entries) to log users onto all (or some subset of) their systems, preferably without any additional user intervention. As will be described in more detail below, the LC also preferably maintains state information for a given user and application, called a “user target”, to help coordinate and execute future operations.

According to the invention, the Global sign-on mechanism preferably uses a “data model” where information used to sign on to applications is kept in two separate databases. The first database is the PKM 424, which is preferably a global database and is thus accessible from all client machines in a given domain. The PKM 424, as noted above, keeps the user's target configuration information. The second database is the CIM 422, which is preferably a local database and is thus accessible only from the current client machine. The CIM need not be merely a local database, however. Each client machine from which the GSO support is provided runs a CIM. Thus, multiple instances of CIM 422 are illustrated in FIG. 4. Likewise, each client machine preferably also runs an instance of the logon coordinator 426.

Thus, for example, the PKM 424 contains user-specific application data which includes:

Target name—uniquely identifying a user “target”;

Target type—specifies what type of “application” this target is;

Domain/Host/Application name—specifies application information, specific for this target;

User ID—specifies user id on target;

Key information—specifies the user's key (password) on the target;

User preferences—specifies user specific information for this target; and

Preferred program name—specifies a preferred CIM entry to use with this target.

The personal key manager 424 enables a given GSO user to manage all the passwords the user possesses in a secure and effective manner. According to the invention, each application, server, or system to which a user needs an ID/password pair to logon is defined as a “target”. Using a GUI interface, the user creates a target in PKM corresponding to each real target to which the user can logon, and the user may create as many (or as few) targets as the capability of a specific PKM implementation allows (or that the user desires). Independent of any implementation, a generic PKM application programming interface (API) preferably is used by the GSO framework to create a new target, to update a target's data, to query a target's information (with or without passwords), and to delete an existing target.

The second database, the CIM 422, preferably contains entries derived from the program template files (PTFs). This database contains application (i.e. program) specific information, which includes, for example:

Target type—specifies what type of “application” the program is, i.e. what type of “application” can be accessed as a target using the program;

Default program—indicates if the CIM entry is the default program to use for a target of the given target type;

Specific application information—describes interfaces needed to perform operations like logon, logoff, and the like;

Program Preferences—indicates timeouts and retry counts; and

Interface directory—client-spiecific information on how to locate the application interface code.

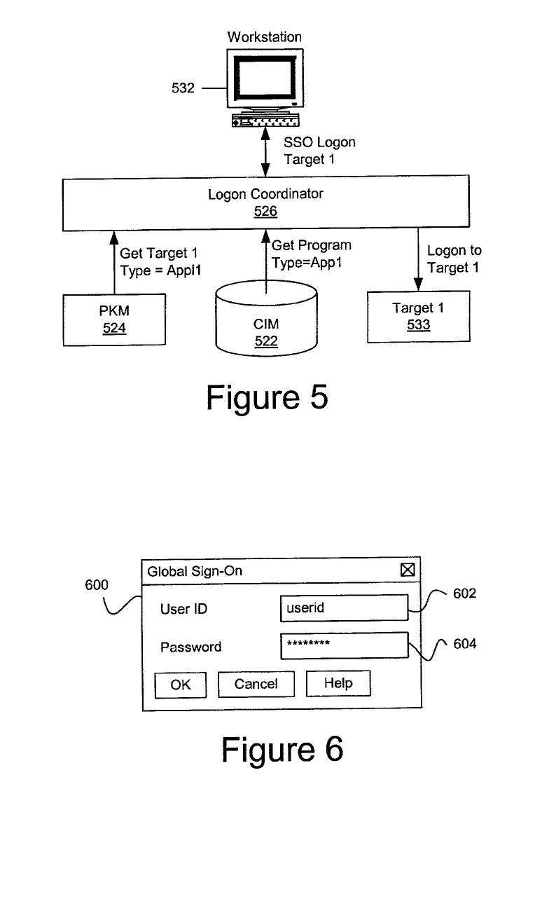

FIG. 5 is a high level illustration of the operation of the logon coordinator. A user at a workstation 532 requests a logon to a given application (Target 1) 533. In response, the logon coordinator 526 issues a query to the PKM 524 for the information regarding the user's “key,” which, as described above, may include the username, password, and any other application environment-specific information as described above. The information is returned to the logon coordinator. Then, the LC issues a query to the CIM to obtain the program information and the program information is returned to the LC. The information retrieved from the CIM 522 for the particular application determines how to logon to the application (e.g. what type of invocation to make, what actual invocation, and the like). The logon coordinator 526 substitutes given data received from the PKM into substitution variables in the invocation strings returned from the CIM. In particular, the logon coordinator performs a matching operation; for each PKM target entry, the coordinator determines whether there is a corresponding CIM entry. If so, the substitution binds the two entries together.

The logon coordinator (LC) thus takes the data from the personal key manager (PKM) and the directives in the CIM and interprets the data, together with current state information, to perform a given action. Such action is carried out with respect to the users' systems and applications and includes for example, a logon operation, a change password operation, or a logoff operation.

If a user does not use integrated login, the first time a GSO target shortcut is selected from the desktop, the user is prompted for a GSO user ID and password. If that password is valid, the user obtains a credential (which lasts for a given period of time, such as eight hours) which is maintained on the machine. The credential allows the user to execute logon on other desktop targets without needing an ID and password, thus turning the desktop into a global sign-on environment. When using an integrated login, the user obtains a credential on OS login, and then the user may invoke desktop targets as long as the user holds the credential.

With reference to FIG. 6, an example logon interface screen is shown in accordance with a preferred embodiment of the present invention. Logon interface 600 includes a user ID field 602 and a password field 604. The user may use the logon interface screen to enter the global sign-on ID and password, after which the user may access targets of the GSO without entering additional IDs and passwords.

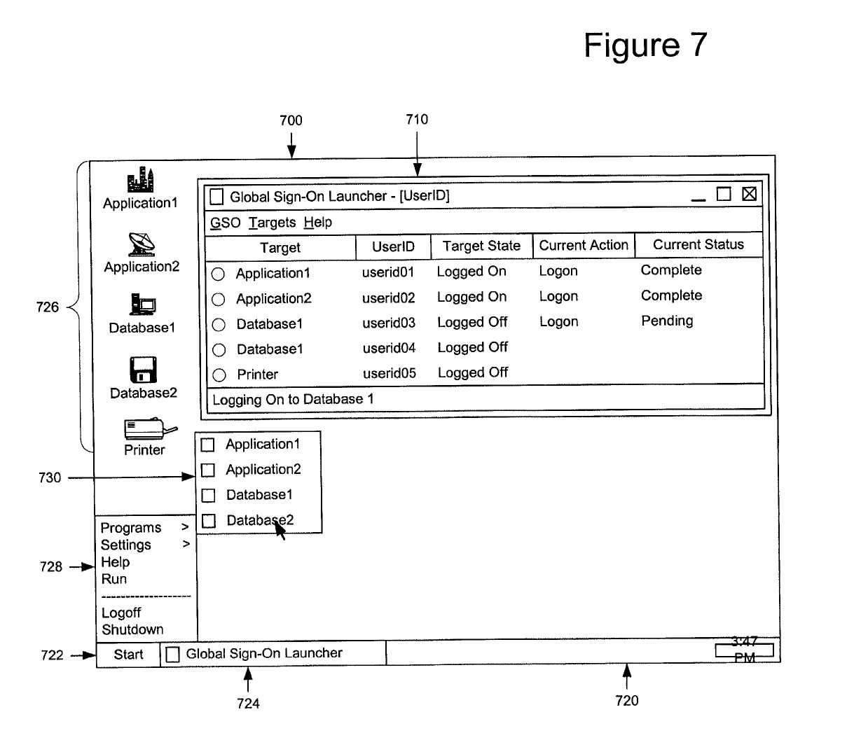

With reference now to FIG. 7, an example desktop user interface is shown in accordance with a preferred embodiment of the present invention. Desktop 700 provides a representation of a workspace on the display screen. The desktop presents window 710 and includes taskbar 720 and icons 726. Taskbar 720 also includes start button 722 and task button 724, which represents an open task. In the example shown in FIG. 7, task button 724 represents window 710. The start button may be selected to invoke start menu 728. The start menu also includes programs submenu 730.

Window 710 may be a global sign-on GUI that displays the systems and applications the user is able to logon to and the status of the logon progress. Targets may be launched through the global sign-on GUI; however, in accordance with a preferred embodiment of the present invention, targets may be represented by icons or start menu items. For example, the global sign-on GUI in window 710 includes the following targets: Application1, Application2, Database1, Database2, and Printer. The global sign-on targets may be represented by icons 726 or by items in program menu 730. This may be accomplished by creating a shortcut for each target. Windows 95/98/NT4/2000 allows users to create pointers, or shortcuts, to program and data files. The shortcut icons may be placed on the desktop or stored in other folders. Double clicking a shortcut is the same as double clicking the original file. However, deleting a shortcut does not remove the original. Shortcuts may also be added to the Start menu.

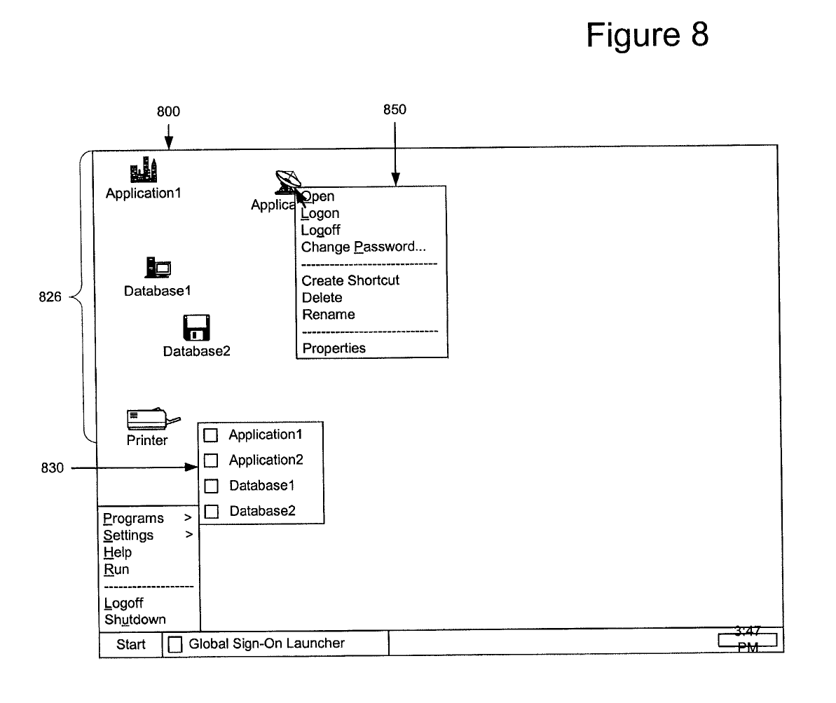

Turning now to FIG. 8, an example desktop user interface with global sign-on target shortcuts is illustrated in accordance with a preferred embodiment of the present invention. Desktop 800 includes GSO target icons 826 and GSO target program menu items 830. The present invention may also create a right click menu for GSO target shortcuts. For example, GSO target right click menu 850 allows a user to open the target, logon to the target, logoff from the target, or change the user password.

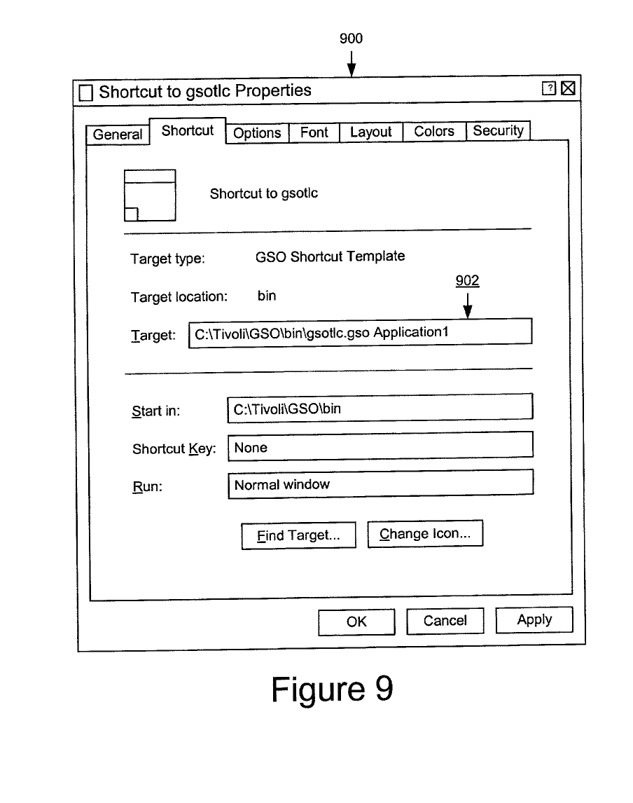

With reference to FIG. 9, a shortcut properties interface is shown in accordance with a preferred embodiment of the present invention. Shortcut properties window 900 allows a user to define the pointer to a target program or data file. The program or data file to which the shortcut points is defined in target field 902. In accordance with a preferred embodiment of the present invention, a shortcut may be created for the global sign-on program file. In this example, the program file name for the global sign-on program is “gsotlc.gso”. In order to create a shortcut for a particular global sign-on target, a user may append the GSO target name after the program file name. Thus the shortcut target becomes “C:\Tivoli\GSO\bin\gsotlc.gso Application1” if the GSO target is “Application1”.

The global sign-on is modified to include a command-line interface. Thus the user may send commands to the global sign-on without the global sign-on GUI being activated. The registry may also be updated to associate desktop features with global sign-on commands. The registry is a database of configuration settings in Windows 95/98/NT/2000. The registry may be updated to customize shortcuts in a known manner. For example, the registry may be updated when the GSO is installed or updated to provide customized right click menus and the like for GSO target shortcuts.

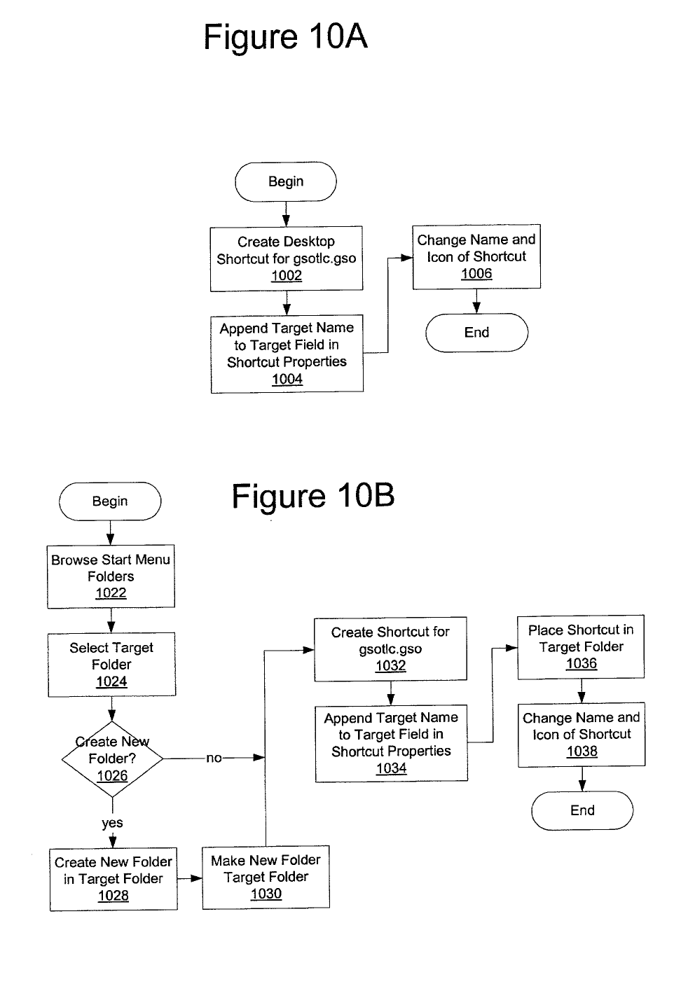

With reference to FIG. 10A, a flowchart is shown illustrating a process for creating a desktop shortcut for a global sign-on target in accordance with a preferred embodiment of the present invention. The process begins and creates a desktop shortcut for the global sign-on program file (step 1002). Next, the process appends the GSO target name to the shortcut target field in the shortcut properties (step 1004), changes the name and icon of the shortcut (step 1006), if appropriate, and ends.

With reference now to FIG. 10B, a flowchart of a process for creating a start menu item for a global sign-on target is shown in accordance with a preferred embodiment of the present invention. The process begins and browses start menu folders (step 1022). Next, the process selects a target folder (step 1024) and a determination is made as to whether a new foder is to be created (step 1026). The target folder is the folder in the start menu in which the GSO target shortcut is to be located. If a new subfolder is to be created in the target folder, the process creates the new folder in the target folder (step 1028) and makes the new folder the target folder (step 1030). Next the process creates a shortcut for the global sign-on program (step 1032).

If step 1026 determines that a new folder is not to be created, the process proceeds to step 1032 to create a shortcut for the global sign-on program. Then, the process appends the GSO target name to the target field in shortcut properties (step 1034) and places the shortcut in the target folder (step 1036). Finally, the process changes the name and icon of the shortcut (step 1038), if appropriate, and ends.

The processes shown in FIGS. 10A and 10B may be performed manually or automatically through software. For example, the global sign-on GUI, shown as window 710 in FIG. 7, may be configured to allow the user to select GSO targets and create desktop shortcuts or start menu items. The global sign-on GUI may also include preferences or menu items to turn shortcuts and start menu items on or off and have the user's preferences apply to all GSO targets. In addition, the global sign-on GUI may allow the user to select whether or not the global sign-on logon interface screen is to be initiated at operating system start-up.

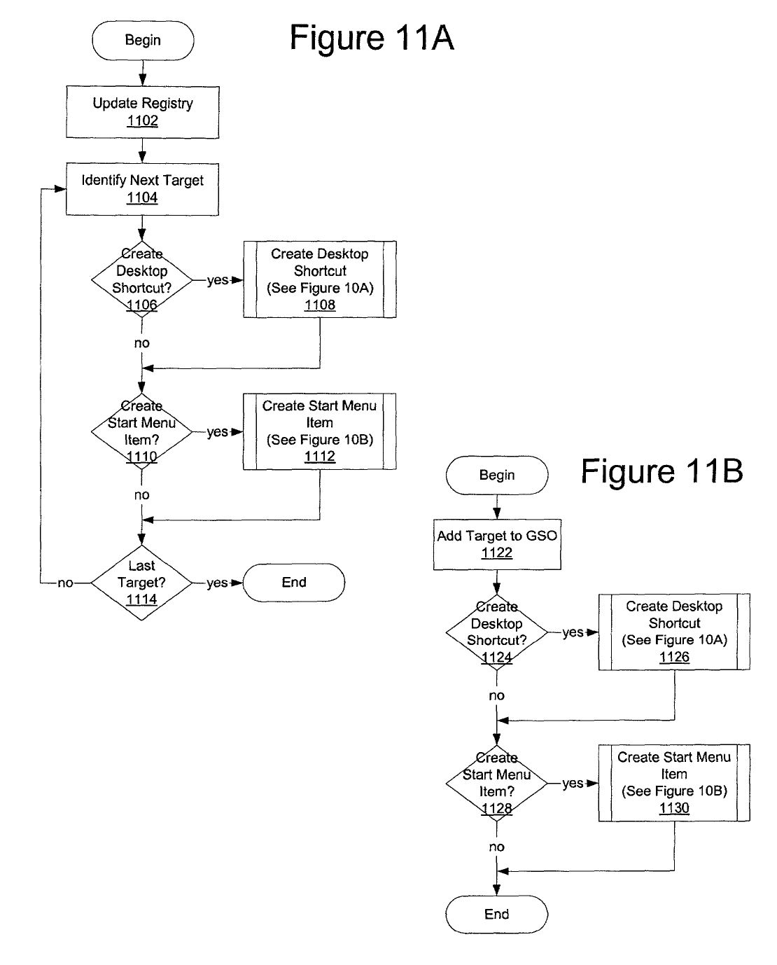

With reference to FIG. 11A, a flowchart illustrating a process for adding global sign-on targets to a desktop is shown in accordance with a preferred embodiment of the present invention. The process begins and updates the registry (step 1102). The registry is a database of configuration settings in Windows 95/98/NT/2000. The registry may be updated to customize shortcuts in a known manner. For example, the registry may be updated to provide customized right click menus and the like for GSO target shortcuts. Step 1102 is a one-time operation and may be omitted if the process is not performed at time of install or update of the GSO.

Next, the process identifies the next GSO target (step 1104) and a determination is made as to whether to create a desktop shortcut (step 1106). If a desktop shortcut is to be created, the process creates a desktop shortcut (step 1108) and a determination is made as to whether to create a start menu item (step 1110). The process for creating a desktop shortcut is described above with respect to FIG. 10A. If step 1106 determines that a desktop shortcut is not to be created, the process proceeds to step 1110 to determine whether to create a start menu item.

If a start menu item is to be created, the process creates a start menu item (step 1112) and a determination is made as to whether the target is the last GSO target (step 1114). The process for creating a start menu item is described above with respect to FIG. 10B. If step 1110 determines that a start menu item is not to be created, the process proceeds to step 1114 to determine whether the target is the last GSO target.

If the target is the last GSO target, the process ends. If the target is not the last GSO target in step 1114, the process returns to step 1104 to identify the next GSO target.

Turning now to FIG. 11B, a flowchart is shown illustrating a process for adding a global sign-on target to the global sign-on system and the desktop in accordance with a preferred embodiment of the present invention. The process begins and adds the target to the global sign-on system (step 1122). A determination is made as to whether to create a desktop shortcut (step 1124). If a desktop shortcut is to be created, the process creates a desktop shortcut (step 1126) and a determination is made as to whether to create a start menu item (step 1128). The process for creating a desktop shortcut is described above with respect to FIG. 10A. If step 1124 determines that a desktop shortcut is not to be created, the process proceeds to step 1128 to determine whether to create a start menu item.

If a start menu item is to be created, the process creates a start menu item (step 1130) and ends. The process for creating a start menu item is described above with respect to FIG. 10B. If step 1128 determines that a start menu item is not to be created, the process ends.

The processes shown in FIGS. 11A and 11B may be performed manually or automatically through software. For example, the global sign-on may be upgraded to include desktop shortcuts. In this example, the global sign-on may automatically cycle through existing GSO targets and prompt the user as to whether to create a desktop shortcut or start menu item. The global sign-on may also automatically prompt the user as to whether to create a desktop shortcut or start menu item when a new GSO target is added.

Thus, the present invention solves the disadvantages of the prior art by integrating global sign-on functionality into the desktop, such that global sign-on targets can be represented as icons or shortcuts, thus making the desktop a global sign-on environment. Global sign-on may be configured with integrated login so that a user may log into the operating system or network environment and select sign-on targets using the familiar desktop environment without having to enter additional identifications or passwords.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for extending a global sign-on environment to a computer desktop, comprising:
creating a data structure, wherein the data structure points to a global sign-on program;
associating the data structure with a global sign-on target; and
presenting a selectable graphical representation of the data structure.

2. The method of claim 1, further comprising:
associating a property of the data structure with a global sign-on command.

3. The method of claim 1, further comprising:
storing the data structure in a folder.

4. The method of claim 3, wherein the folder is a desktop folder and the graphical representation comprises an icon on the computer desktop.

5. The method of claim 3, wherein the folder is a start menu folder and the graphical representation comprises a start menu item.

6. The method of claim 1, wherein the data structure comprises a shortcut.

7. The method of claim 1, wherein the graphical representation comprises an icon.

8. A method for extending a global sign-on environment to a computer desktop, comprising:
presenting a graphical representation of a global sign-on target; and
in response to a user interaction with the graphical representation, performing an action with respect to the global sign-on target.

9. The method of claim 8, wherein the action comprises one of launching the global sign-on target, logging onto the global sign-on target, logging off of the global sign-on target, and changing the password for the global sign-on target.

10. The method of claim 8, wherein the user interaction comprises a double-click of a mouse and the action comprises launching the global sign-on target.

11. The method of claim 8, wherein the user interaction comprises a right-click of a mouse and the action comprises presenting a menu, the menu including global sign-on commands.

12. The method of claim 8, wherein the graphical representation comprises an icon.

13. An apparatus for extending a global sign-on environment to a computer desktop, comprising:
creation means for creating a data structure, wherein the data structure points to a global sign-on program;
association means for associating the data structure with a global sign-on target; and
presentation means for presenting a selectable graphical representation of the data structure.

14. The apparatus of claim 13, further comprising:
means for associating a property of the data structure with a global sign-on command.

15. The apparatus of claim 13, further comprising:
storage means for storing the data structure in a folder.

16. The apparatus of claim 15, wherein the folder is a desktop folder and the graphical representation comprises an icon on the computer desktop.

17. The apparatus of claim 15, wherein the folder is a start menu folder and the graphical representation comprises a start menu item.

18. The apparatus of claim 13, wherein the data structure comprises a shortcut.

19. The apparatus of claim 13, wherein the graphical representation comprises an icon.

20. An apparatus for extending a global sign-on environment to a computer desktop, comprising:
presentation means for presenting a graphical representation of a global sign-on target; and
interface means for performing an action with respect to the global sign-on target in response to a user interaction with the graphical representation.

21. The apparatus of claim 20, wherein the action comprises one of launching the global sign-on target, logging onto the global sign-on target, logging off of the global sign-on target, and changing the password for the global sign-on target.

22. The apparatus of claim 20, wherein the user interaction comprises a double-click of a mouse and the action comprises launching the global sign-on target.

23. The apparatus of claim 20, wherein the user interaction comprises a right-click of a mouse and the action comprises presenting a menu, the menu including global sign-on commands.

24. The apparatus of claim 20, wherein the graphical representation comprises an icon.

25. A computer program product, in a computer readable medium, for extending a global sign-on environment to a computer desktop, comprising:
instructions for creating a data structure, wherein the data structure points to a global sign-on program;
instructions for associating the data structure with a global sign-on target; and
instructions for presenting a selectable graphical representation of the data structure.

26. A computer program product, in a computer readable medium, for extending a global sign-on environment to a computer desktop, comprising:
instructions for presenting a graphical representation of a global sign-on target; and
instructions for performing an action with respect to the global sign-on target in response to a user interaction with the graphical representation.
